(19) United States
(12) Patent Application Publication
(10) Pub. No.: US 2004/0227417 A1
(43) Pub. Date: Nov. 18, 2004

(54) Electric motor

(75) Inventors: Tomonaga Yamamoto, Fujiyoshida-shi (JP); Masami Kimijima, Minamitsuru-gun (JP)

Correspondence Address: BURNS DOANE SWECKER & MATHIS L L P, POST OFFICE BOX 1404, ALEXANDRIA, VA, 22313-1404, US

(73) Assignee: FANUC, LTD

(21) Appl. No.: 10/844,147

(22) Filed: May 12, 2004

(30) Foreign Application Priority Data
May 13, 2003 (JP) 2003-134560

(51) Int. Cl. H02K 3/50

(52) U.S. Cl. 310/71

(57) ABSTRACT

An electric motor in which ends of lead wires of stator winding can be easily connected to a connector and the time for assembling the motor becomes shorter. The motor includes a stator winding having a plurality of lead wires, a plurality of conductors or conductive parts each electrically connected to each end of the lead wires, and a junction member having an insulator for integrally holding the conductive parts. The conductive parts and the ends of the lead wires of the stator winding may be connected to each other, respectively, by fusing members. As each of the conductive parts is configured to be disposed along a shape of a coil end of the motor, the conductive parts do not protrude to the inside of the stator winding or the outside of the coil end, and the insulator is held at a predetermined position. Therefore, in order to assemble the motor, it is not necessary to stow the lead wires or the like protruding to the inside of the stator or the outside of the motor into a housing of the motor, whereby assembling of the motor becomes easier and the time for the assembling becomes shorter.

### BACKGROUND OF THE INVENTION

1. Field of the Invention

The present invention relates to an electric motor.

2. Description of the Related Art

Conventionally, a connection between an end of a lead wire of a stator winding and a connector for supplying a power to the stator winding is achieved by soldering. FIG. 6 shows an example of an electric motor 20 in which a connection between lead wires 21U, 21V and 21W of U, V and W phases of a stator winding of the motor and a power connector 30 is achieved by soldering by means of a solder 40. As shown, ends of the lead wires 21U, 21V and 21W of the stator winding must be moved to a position of the power connector 30. Further, because the lead wires are flexible, the lead wires must be accommodated in a housing of the motor 20 such that the lead wires do not protrude toward the inside of the stator or the outside of a coil end of the motor 20.

In a process prior to the soldering, an enamel coating on an end of the lead wire is removed by burning and brushing. Possible problems, such as insufficiency of removal of the coating, burning of the lead wire by heating it too much, and/or defects of in the soldering, may deteriorate the quality of the motor.

As a method for connecting the lead wire to a pigtail of the connector, for supplying power, without soldering, several connection methods are known, as shown below: Japanese Patent Publication (Kokai) No. 2002-84701 discloses a connection method including bundling the lead wire and the pigtail, and crimping them using a metal tube or the like; Japanese Patent Publication (Kokai) No. 11-275793 discloses a connection method using fusing; and Japanese Patent Publication (Kokai) No. 2001-95201 discloses a connection method using welding. In these methods, the end of the lead wire and the pigtail are directly connected each other.

On the other hand, Japanese Patent Publication (Kokai) No. 2000-69705 discloses a connection method including fixing a terminal block in a housing of a motor, and fusing each phase terminal of the terminal block and an end of each phase lead wire of a stator winding.

As described in the above Japanese Patent Publication (Kokai) No. 2002-84701, No. 11-275793 and No. 2001-95201, in a method including directly connecting the end of the lead wire of the stator winding to the pigtail for supplying a power and drawing the lead wire to the outside of the motor, the lead wire can be moved freely. Therefore, the lead wire must be fixed to the housing of the motor or the like, by a certain way or means, such that the lead wire is prevented from freely moving. As a result, the production time of the motor is disadvantageously increased.

Also, in the method of the above Japanese Patent Publication (Kokai) No. 2000-69705, the lead wire may be freely bent, therefore, the wire must be fixed and the production time of the motor is increased.

### SUMMARY OF THE INVENTION

It is an object of the present invention to provide an electric motor capable of being assembled easily and able to facilitate a connection between the ends of lead wires of a stator winding and a power connector such that the production time of the motor is short.

In accordance with the present invention, an electric motor is provided, which comprises a stator winding having a plurality of lead wires, a junction member having a plurality of conductive parts connected to ends of the lead wires and an insulator for integrally fixing the conductive parts, the conductive parts are formed to be disposed along a shape of the stator winding and substantially fixed relative to the stator winding.

The junction member may further comprise a male-type or a female-type pin, or a connector structure conforming to a pin, which is electrically connected to a conductive part and is arranged on the insulator.

The male-type or the female-type pin, or the connector structure may be directly connected to a power connector positioned on a cable side.

The conductive parts of the junction member and the ends of the lead wires of the stator winding may be connected to each other by fusing.

### BRIEF DESCRIPTION OF THE DRAWING

The above and other objects, features and advantages of the present invention will be made more apparent, from the following description of the preferred embodiments thereof, with reference to the accompanying drawings, wherein:

FIG. 1 is a side view of an example of a junction member of one embodiment of an electric motor of the invention;

FIG. 2 is a front view of the junction member of FIG. 1;

FIG. 3 is a view for explaining the embodiment of the motor provided with the junction member;

FIG. 4 is a for indicating an example of a connection between the motor of the embodiment and a power connector;

FIG. 5 is a schematic view for explaining an example in which the junction member is connected to a power connector arranged on a cable side without using a power connector arranged on a motor side; and

FIG. 6 is a view for explaining an electric motor of the prior art in which lead wires of a stator winding of the motor are connected to a power connector by soldering.

### DETAILED DESCRIPTION

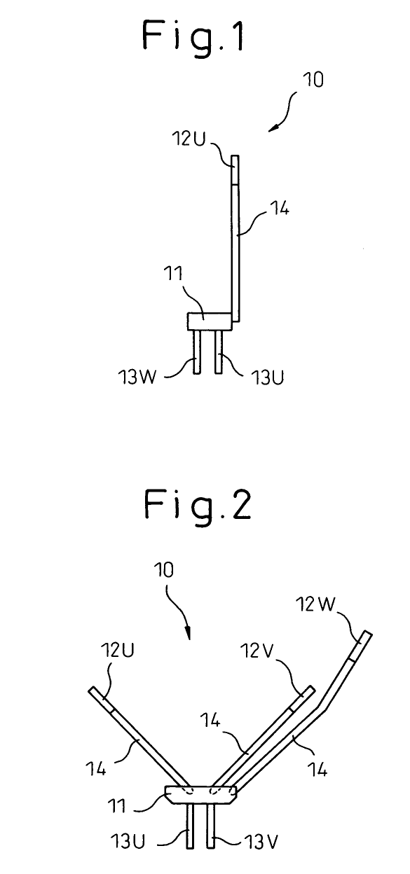

FIGS. 1 and 2 are a side view and a front view, respectively, of an example of a junction member 10 of a three-phase motor of the invention, which electrically connects ends of lead wires of a stator winding of the motor to a power connector. The junction member 10 includes an insulator 11 and conductor or conductive parts 12U, 12V and 12W of three-phases formed of copper or the like. Each of the conductive parts 12U, 12V and 12W is electrically connected to each phase end of the each lead wire (i.e., U, V or W phase). These conductive parts 12U, 12V and 12W are integrated by fixing one end of each conductive part to the insulator 11, and electrically connecting the ends of the parts to male-type pins 13U, 13V and 13W, protruding from the insulator 11, respectively. The pins 13U, 13V and 13W are positioned on three of the four corners of a rectangular shape, respectively, and no pin is positioned on the remaining corner. In FIG. 2, reference numeral 14 indicates an insulating layer or a coating for insulating the conductive part 12U, 12V or 12W.

The conductive parts 12U, 12V and 12W of the junction member 10 have plasticity and are formed such that the conductive parts are positioned along the shape of the stator winding of the motor provided with the junction member 10.

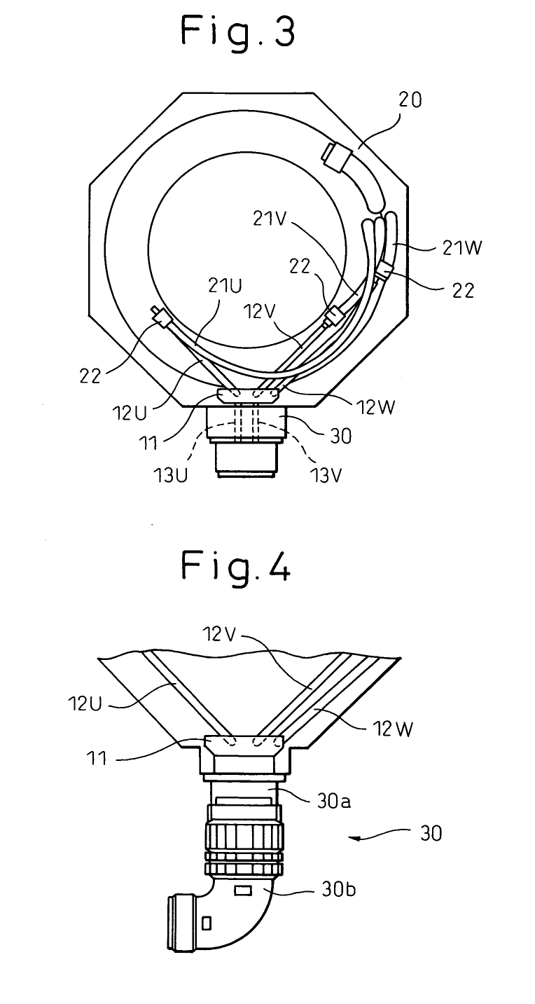

FIG. 3 indicates the junction member 10 applied to an electric motor 20 and connected to a power connector 30. The ends of the lead wires 21U, 21V and 21W of the three-phase windings of the motor 20 and the ends of the corresponding conductive parts 12U, 12V and 12W are electrically connected to each other, respectively, by fusing members 22. For example, the end of the lead wire 21U of U-phase of the stator winding and the end of the conductive part 12U of U-phase are bundled, crimped by the fusing members 22 and electrically connected to each other. Similarly, the ends of the lead wires 21V and 21W of V and W-phases of the stator winding and the ends of the conductive parts 12V and 12W of V and W-phases are bundled, crimped by the fusing members 22 and electrically connected to each other, respectively.

In this case, the conductive parts 12U, 12V and 12W are configured such that the parts are disposed along the shape of an end portion of the stator winding of a stator coil and configurations of the parts may be retained. Therefore, the conductive parts 12U, 12V and 12W cannot protrude into the inside of the stator or the outside of the coil end. Moreover, as the conductive parts 12U, 12V and 12W are integrally mounted to the insulator 11, the position of the insulator 11 in the motor 20 is naturally, and determined, therefore, the insulator 11 may be held at a desired position in the motor 20 without being fixed by a particular fixing means. Then, the junction member 10 may be substantially fixed by a tail end cover when the cover is attached to a housing of the motor 20. The male-type pins 13U, 13V and 13W protruding from the insulator 11 are engaged with female-type pins of the power connector 30 and electrically connected to the power connector 30.

As described above, the connection between the lead wires 21U, 21V and 21W of three-phases of the stator coil and the power connector 30 are achieved only by fusing and connecting the ends of the lead wires 21U, 21V and 21W and the ends of the conductive parts 12U, 12V and 12W, respectively, by means of the fusing members 22. Further, none of the lead wires 21U, 21V and 21W and the conductive parts 12U, 12V and 12W protrudes to the inside of the stator or the outside of the motor, therefore, an operation of assemble of the motor 20 may be carried out remarkably easily, and the efficiency of the operation may be increased.

FIG. 4 is a view for explaining a condition in which the power connector 30 is mounted to the motor 20 including the junction member 10 installed therein. A motor side power connector 30a of the connector 30 is connected to the male-type pins 13U, 13V and 13W of the junction member 10, and a cable side power connector 30b is attached to the motor side power connector 30a, whereby the stator winding and a cable (not shown) to be connected the cable side connector 30b may be electrically connected to each other.

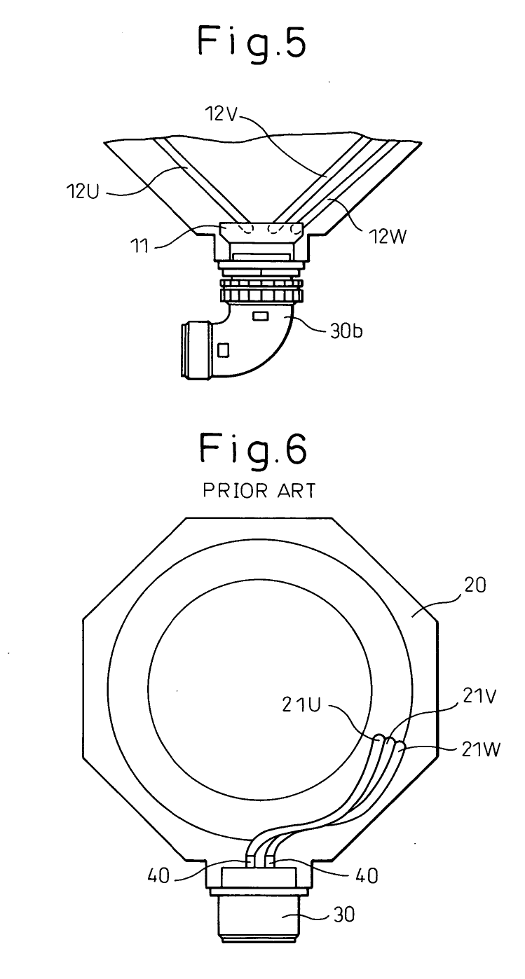

Otherwise, because the junction member 10 has the male-type pins 13U, 13V and 13W protruding from the insulator 11, it is possible to directly connect the cable side power connector 30b to the junction member 10 as a set of female-type pins, as shown in FIG. 5. In FIG. 5, the motor side power connector 30a is not used, and the junction member 10 functions also as a motor side connector. Therefore, a number of components of the motor, and thus, a product cost of the motor may be decreased.

Although the male-type pins 13U, 13V and 13W are arranged on the junction member 10, female-type pins may be arranged on the junction member 10 instead.

The lead wires of the stator winding may be connected to the power connector for supplying to the stator winding by the conductors or conductive parts configured to be disposed along the shape of the coil end of the stator winding. Therefore, the lead wires do not protrude to the inside of the stator or the outside of the coil end, and are held in predetermined shapes at a connection point between the power connector and the lead wires of the stator winding, which makes the operation of assemble remarkably easy. Further, because the junction member connecting the lead wires of the stator winding to the power connector is formed of the conductors or conductive parts and the pins or the connector structure conforming to the pins, the motor may be formed more compactly compared to a motor of the prior art having a base connector. Moreover, the motor may be connected to the power connector by pin-connection and, therefore, the power connector can be easily disconnected and maintainability of the motor may be improved.

While the invention has been described with reference to specific embodiments chosen for the purpose of illustration, it should be apparent that numerous modifications could be made thereto, by one skilled in the art, without departing from the basic concept and scope of the invention.

1. An electric motor comprising:
a stator winding having a plurality of lead wires; and
a junction member having a plurality of conductive parts electrically connected to ends of the lead wires and an insulator for integrally fixing the conductive parts;
wherein the conductive parts are formed to be disposed along a shape of the stator winding and are substantially fixed relative to the stator winding.

2. The electric motor as set forth in claim 1, wherein the junction member further comprises a male-type or a female-type pin, or a connector structure conforming to a pin, which is electrically connected to the conductive parts and is arranged on the insulator.

3. The electric motor as set forth in claim 2, wherein the male-type or the female-type pin, or the connector structure, is directly connected to a power connector positioned on a cable side.

4. The electric motor as set forth in claim 1, wherein the conductive parts of the junction member and the ends of the lead wires of the stator winding are connected to each other by fusing.
